(19) United States
(12) Patent Application Publication
(10) Pub. No.: US 2006/0264319 A1
(43) Pub. Date: Nov. 23, 2006

(54) Method of preparing electrochemical catalyst for proton exchange membrane fuel cell

(75) Inventors: Duck-young Yoo, Seoul (KR); Baolian Yi, Daillan (CN); Huamin Zhang, Daillan (CN); Jianlu Zhang, Daillan (CN)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/371,077

(22) Filed: Mar. 9, 2006

(30) Foreign Application Priority Data
Mar. 9, 2005 (CN) 200510045987.X
Feb. 21, 2006 (KR) 2006-16671

(51) Int. Cl. H01M 4/88; B01J 21/18; B01J 23/42

(52) U.S. Cl. 502/101; 502/339; 502/185

(57) ABSTRACT

A method of preparing electrochemical catalyst for proton exchange membrane fuel cells (PEFC), more particularly, a method of preparing a nano-sized, Pt-based bi-component or multi-component electrochemical catalyst for an anode and a cathode of PEFC that enables preparation of an electrochemical catalyst for PEFC, which has high activity, is simply prepared, and has active components uniformly distributed therein.

### CROSS-REFERENCE TO RELATED APPLICATIONS

This application claims the benefit of Chinese Patent Application No. 200510045987.X, filed on Mar. 9, 2005 in the Chinese Intellectual Property Office, and Korean Patent Application No. 2006-16671, filed on Feb. 21, 2006 in the Korean Intellectual Property Office, the disclosures of which are incorporated herein in their entirety by reference.

### BACKGROUND OF THE INVENTION

1. Field of the Invention

An aspect of the present invention relates to a method of preparing an electrochemical catalyst for proton exchange membrane fuel cells (PEFC), and more particularly, to a method of preparing a nano-sized, Pt-based bi-component or multi-component electrochemical catalyst for an anode and a cathode of PEFC.

2. Description of the Related Art

Fuel cells have received significant attention in view of their advantages such as high efficiency, low emissions, and convenient starting. In particular, PEFC, which generally operate at a low temperature of about 80° C. and are based on a polymer proton conducting membrane that acts as an electrolyte, have received more attention and are regarded as influential alternatives for vehicles and portable electronic products as power sources.

The principle of PEFC is as follows. A fuel cell includes an anode, a cathode, and a polymer electrolyte membrane that physically separates the anode and the cathode. Hydrogen is supplied to the anode and oxygen is supplied to the cathode. When the anode and the cathode are connected to form a circuit, for example, by being connected to an external power consumption circuit, operation of the fuel cell is initiated.

In the anode, hydrogen is decomposed into 2 protons and 2 electrons as represented by formula 1.
H₂→2H⁺+2e⁻ Formula 1

The produced proton easily migrates from the anode to the cathode through the polymer electrolyte membrane. However, the polymer electrolyte membrane that is an electric insulator prevents electrons from migrating from the anode to the cathode.

In the cathode, oxygen is reduced as represented by formula 2.
O₂+4H⁺+4e⁻→2H₂O Formula 2

Thus, the operation of the fuel cell is summarized in that the hydrogen supplied to the anode combines with oxygen supplied to the cathode to produce water and electric energy.

Reactions in electrodes of PEFC are caused by an electrochemical catalyst, which is one of essential materials of PEFC. Slow reduction of oxygen occurs in the cathode, which causes overvoltage in the cathode. In the anode, fast oxidation of hydrogen occurs. Although pure hydrogen is an ideal fuel of PEFC, it is expensive and has limitations in terms of storage and transportation. Currently, as alternatives thereto, reformed gas is used or hydrogen is directly prepared from methanol or other liquid fuels in vehicles, etc. However, the reformed gas or hydrogen prepared from methanol or other liquid fuels inevitably contains more or less carbon monoxide (CO) (up to 1 vol %) according to a degree of purification.

CO has higher affinity to a Pt catalyst, which is used in most fuel cells, than hydrogen. When CO-containing hydrogen is used, CO molecules occupy a specific active site of a Pt catalyst surface, resulting in a decrease in accessibility of hydrogen molecules to the active site. As a result, a fuel cell has reduced efficiency. This is called “the poisoning” of a catalyst.

Recently, many catalysts containing other components have been prepared using various methods. A cathode catalyst is a bicomponent or multi-component catalyst which is primarily composed of Pt, Fe, Co, Ni, Cr, Cu and the like and a CO tolerant electrochemical catalyst is a bi-component or multi-component catalyst which is primarily composed of Pt, Ru, Rh, Pd, Ir, W, Mo, Sn, Mn and the like. A PtRu catalyst has the best CO tolerance, and thus has been widely used for PEFC and direct methanol fuel cells (DMFCs).

A PEFC catalyst is prepared using any one of an impregnation-reduction method, a colloidal method, and a Bonnemann method.

The impregnation-reduction method includes, for example, reducing an aqueous solution of a precursor of a metal such as Pt and depositing the metal onto a carbon support. Alternatively, an active metal precursor is reduced prior to impregnation on a carbon support and the reduced metal is deposited on a carbon support. NaBH₄, HCHO, HCOOH, HCOONa, N₂H₄ and the like are used as reducing agents. A PtRuPd/C catalyst prepared using Na₂S₂O₃ as a reducing agent is disclosed in U.S. Pat. No. 5,208,207 (P. Stonehart, M. Watanabe; Kikinzoku Kogyo K. K. and Stonehart Associates, Inc.; published on 4 May 1993). The impregnation-reduction method provides non-uniform catalysts since it is difficult to control preparation conditions such as solvent and pH.

The colloidal method includes preparing a colloidal metal oxide, depositing the colloidal metal oxide onto a carbon support, and treating the resultant to obtain a catalyst.

A Pt/C catalyst prepared using the colloidal method is disclosed in U.S. Pat. No. 3,992,331 (H. G. Petrow, R. G. Allen, published on 16 Nov. 1976). First chloroplatinic acid is converted into Na₆[Pt(SO₃)₄]. Then, Na⁺ of Na₆[Pt(SO₃)₄] is substituted with H⁺ through ion exchange. H₆[Pt(SO₃)₄] is heated to separate SO₃²⁻ and dried to obtain a colloidal Pt oxide. This colloid has a black color and a dispersion thereof in water or other solvents can be easily deposited onto a support.

M. Watanabe prepared a PtRu/C catalyst using the colloidal method (J. Electroanal. Chem., 229 (1987) 395). First, chloroplatinic acid is converted into Na₆[Pt(SO₃)₄]. Then, Na₆[Pt(SO₃)₄] is decomposed by adding excess H₂O₂ to obtain a Pt oxide in a stable colloidal phase. An Ru compound such as RuCl₃ is added to the colloidal Pt oxide and Ru is oxidized into an Ru oxide. Then, metal clusters are formed due to interaction between the Ru oxide and the Pt oxide. The clusters are deposited onto a support and the metals are reduced with hydrogen.

A. K. Shukla also prepared a PtRu/C catalyst using the colloidal method (J. Appl. Electrochem., 29 (1999) 129). Precursors of Pt and Ru are individually converted into Na₆[Pt(SO₃)₄] and Na₆[Ru(SO₃)₄] and separated. Then, Na₆[Pt(SO₃)₄] and Na₆[Ru(SO₃)₄] are mixed and oxidized with H₂O₂ to obtain a mixture of colloidal metal oxides. Finally, the mixture is deposited onto a support.

U.S. Pat. No. 5,641,723 discloses a method of preparing a PEFC electrochemical catalyst using the Bonnemann method (H. Bonnemann et al., published on 24 Jun. 1997). In the Bonneman method, a PtRh/C catalyst is prepared in saturated C₅-C₁₀ hydrocarbon, aromatic hydrocarbon, ethers, esters, and ketones, more specifically, n-pentane, hexane, benzene, toluene, THF, diethyl ether acetone, ethyl acetate, or a mixture thereof. Water and oxygen cannot be used in the method. Moreover, the method is complicated and expensive.

According to another aspect of the present invention, an incipient wetness method is used to prepare an electrochemical catalyst for PEFC. According to another aspect of the present invention, ethylene glycol acts as a solvent and a ligand.

### SUMMARY OF THE INVENTION

An aspect of the present invention provides a method of preparing an electrochemical catalyst for PEFC which has high catalytic activity, has active components uniformly distributed therein, is simple to prepare, and is environmentally friendly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating performance of a single PEFC unit, in which PtRu/C catalysts having a Pt/Ru atomic ratio of 1:1, 2:1 and 1:2 (PtRu11/C, PtRu21/C, and PtRu12/C) are used as anode catalysts, 100 ppm CO/H₂ is used as a fuel, and oxygen is used as an oxidant;

FIG. 2 is a CO stripping cyclic voltammogram of thin film electrodes including a PtRu11/C catalyst and a 20 wt % Pt/C catalyst;

FIG. 3 is a graph illustrating performance of a single cell, in which a PtFe/C catalyst having a Pt/Fe atomic ratio of 5:5 (PtFe55/C) and a PtCo/C catalyst having a Pt/Co atomic ratio of 2:1 (PtCo11/C) are used as cathode catalysts, H₂ is used as a fuel, and air is used as an oxidant; and

FIG. 4 is a transmission electron microscopic (TEM) image of a PtFe55/C catalyst.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An aspect of the present invention relates to a method of preparing a highly active and uniform electrochemical catalyst for PEFCs. Active components of the electrochemical catalyst are Pt and a transition metal, more specifically, at least one transition metal selected from Ru, Rh, Pd, Os, Ir, Ag, W, Cu, Fe, Co, Ni, Mo, Cr and Mn.

An atomic ratio of Pt to the other active component is 10:1 to 1:10. When the atomic ratio of Pt to the other active component does not lie within the above-described range, the activity of the catalyst is low.

The total amount of Pt and the other active component is about 5-80 wt % based on the weight of the support and catalyst. When the total weight of Pt and the other active component is less than about 5 wt % based on the weight of the support and catalyst, the activity of the supported catalyst is too low and when the total weight of Pt and the other active component is greater than about 80 wt %, it is not cost-effective.

The amount of Pt supported on a support may be 5-60 wt % based on the weight of the support and catalyst. When the amount of Pt is less than 5 wt % based on the weight of the support and catalyst, the activity of the supported catalyst is low and when the amount of Pt is greater than 60 wt % based on the weight of the support and catalyst, it is not cost-effective.

A supported catalyst may be prepared as follows. First, an active component precursor is dissolved in an alcohol solvent. The solution is mixed with a support using an incipient wetness method. Then, the mixture is heated to 50-95° C. under stirring and dried in vacuum. Finally, the dried mixture is thermally treated under H₂/inert gas atmosphere, preferably at 200-600° C. for 0.5-10 hours. The method according to an aspect of the present invention is simple and easily managed. In addition, the method can provide an electrochemical catalyst which is environmentally friendly, has high catalytic activity and has active components uniformly distributed therein. Moreover, the method can be widely used in methods of preparing various catalysts.

Another aspect of the present invention relates to a method of preparing a highly active and uniform electrochemical catalyst for PEFC. An incipient wetness method is applied to the method of the present invention. In the method, ethylene glycol may be used as a solvent and a ligand. A catalyst prepared using the method has high catalytic activity and has active components uniformly distributed therein. The method is simple, easily managed, and environmentally friendly.

An impregnation-reduction method generally provides non-uniform catalysts since it is difficult to control preparation conditions such as solvent and pH. A colloidal method is very complicated and is difficult to be industrialized. A Bonnemann method does not work in the presence of water and oxygen, is not environmentally friendly, is complicated, and has high costs.

According to another aspect of the present invention, there is provided a method of preparing an electrochemical catalyst for PEFC, which has high activity and active components uniformly distributed therein, and is simple to prepare.

According to an embodiment of the present invention, active components of the electrochemical catalyst are Pt and at least one transition metal selected from Ru, Rh, Pd, Os, Ir, Ag, W, Cu, Fe, Co, Ni, Mo, Cr and Mn. An atomic ratio of Pt to the other active component is 10:1 to 1:10. The amount of active components in the electrochemical catalyst is 5-80 wt %.

A method of preparing catalysts generally includes: dissolving a Pt precursor and a precursor of an active component in a solvent to form a uniform solution; mixing the solution and a support, in which the amount of the solution is the maximum amount of the solution that can be completely absorbed by the support; surface-drying the mixture by heating the mixture to evaporate the solvent and completely drying the mixture at a higher temperature than the surface-drying temperature; and performing a thermal treatment on the mixture under H₂/inert gas atmosphere.

The support is generally activated carbon, conductive carbon, graphite, nano-carbon tube, nano-carbon fiber, carbon molecular sieve, or a Pt/C catalyst which is supported on the above-described supports and contains 5-60 wt % of Pt.

The solvent may be a C₂-C₈ binary alcohol or a C₂-C₈ ternary alcohol. The C₂-C₈ binary alcohol or the C₂-C₈ ternary alcohol may contain 0-60 vol % of water. For example, the solvent may be ethylene glycol or an aqueous solution thereof. Ethylene glycol does not only act as a solvent but also as a ligand in the method. When the content of water in the solvent is greater than 60 vol %, the supported catalyst is not easily formed due to a too low content of the alcohol which acts as a solvent and a ligand.

The precursors of Pt and other active components are dissolved in the solvent to form a uniform solution.

The mixing the solution and a support, in which the amount of the solution is the maximum amount of the solution that can be absorbed by the support, may be a method commonly known as the incipient wetness method.

The support which has absorbed the solution is heated to 50-95° C. under stirring and the solvent is evaporated until the surface of the mixture is dried. When the surface-drying temperature is lower than 50° C., drying is insufficient and when the surface-drying temperature is higher than 95° C., it is difficult to form a nano-sized uniform catalyst due to bubbles produced by water.

The dried mixture may be heated and dried at a higher temperature than the surface-drying temperature in vacuum to more completely remove the solvent. This drying process may be performed at 60-150° C. for 2-24 hours. When the drying temperature is lower than 60° C., drying is insufficient and when the drying temperature is higher than 150° C., the Pt precursor and the active component precursor are decomposed to form a metal oxide, which deteriorates catalytic activity. When the drying time is shorter than 2 hours, drying is insufficient and when the drying time is longer than 24 hours, it is not cost-effective.

The thermal treatment may be performed under inert gas atmosphere optionally containing reductive gas. The inert gas may be Ar, He, or N₂. The fraction of hydrogen in H₂/inert gas may be 0-90 vol %. When the fraction of hydrogen is greater than 90 vol %, the size of a catalytic metal particle is significantly increased due to excessive reduction.

In the thermal treatment, a heating rate is 0.1-20° C./min and a thermal treatment temperature is 200-600° C. When the heating rate is less than 0.1° C./min, it takes too much time to increase the temperature to the thermal treatment temperature and when the heating rate is greater than 20° C./min, the size of a catalytic metal particle is significantly increased. When the thermal treatment temperature is lower than 200° C., the catalyst is not easily reduced and when the thermal treatment temperature is higher than 600° C., the size of a catalytic metal particle is significantly increased.

Also, the thermal treatment may be performed for 0.5-10 hours. When the thermal treatment time is shorter than 0.5 hour, the metal complex compound on the support is not easily reduced and when the thermal treatment time is longer than 10 hours, the size of a catalytic metal particle is significantly increased.

Since the solution of active components on the complex compound of ethylene glycol is homogeneous before it is deposited on the support, metals are uniformly distributed on the support. The metal complex compound of ethylene glycol is easily decomposed at a relatively low temperature and no impurity is introduced in the method. The method of preparing a catalyst is simple and easy to manage.

The method of the present embodiment has the following advantages compared to conventional methods.

1. A preparation process of catalysts is simple and can be easily managed and industrialized.

2. No impurity is introduced during the preparation of the catalyst.

3. Since the solution of active components on the complex compound of ethylene glycol is homogeneous before it is deposited on the support, metals are uniformly distributed on the support and the interaction between metals is very strong.

4. The method according to an aspect of the present embodiment can be used to prepare an oxygen-reducing catalyst of a cathode for PEFC as well as a CO tolerant catalyst. The method can also be used to prepare a bi-component or multi-component catalyst.

The catalyst prepared using the method according to an embodiment of the present invention has high catalytic activity and has active components uniformly distributed therein. Moreover, the preparation method of the catalyst is simple, easily managed, and environmentally friendly.

An aspect of the present invention will now be described in greater detail with reference to the following examples. The following examples are for illustrative purposes and are not intended to limit the scope of the invention.

### EXAMPLE 1

### PtRu11/C Electrochemical Catalyst of the Present Invention

0.26 g of RuCl₃ was dissolved in 2.5 mL of an aqueous solution of ethylene glycol (water content 1.0 vol %) to prepare a uniform solution. 1.0 g of 20 wt % Pt/C catalyst was added to the solution and stirred for 1 hour to prepare a uniform mixture. The mixture was heated to 60° C. to evaporate the solvent until the surface of the mixture was dried. Then, the mixture was dried in vacuum at 110° C. for 8 hours. Finally, the dried mixture was heated at a rate of 1° C./min and thermally treated at 600° C. for 4 hours under 2 vol % H₂/N₂ atmosphere.

### COMPARATIVE EXAMPLE 1

The 20 wt % Pt/C catalyst used in Example 1 was used.

The supported catalysts of Example 1 and Comparative Example 1 were used to manufacture thin film electrodes. FIG. 2 is a CO stripping cyclic voltammogram of the thin film electrodes. Referring to FIG. 2, the CO stripping potential of Example 1 is higher than that of Comparative Example 1, which indicates that the PtRu11/C catalyst has better CO tolerance.

### EXAMPLE 2

### PtRu12/C Electrochemical Catalyst of the Present Invention

0.52 g of RuCl₃ was dissolved in 2.5 mL of an aqueous solution of ethylene glycol (water content 5.0 vol %) to prepare a uniform solution. 1.0 g of 20 wt % Pt/C catalyst was added to the solution and stirred for 1 hour to prepare a uniform mixture. The mixture was heated to 80° C. to evaporate the solvent until the surface of the mixture was dried. Then, the mixture was dried in vacuum at 130° C. for 8 hours. Finally, the dried mixture was heated at a rate of 5° C./min and thermally treated at 500° C. for 2 hours under 5 vol % H₂/N₂ atmosphere.

### EXAMPLE 3

### PtRu21/C Electrochemical Catalyst of the Present Invention

0.13 g of RuCl₃ was dissolved in 2.5 mL of an aqueous solution of ethylene glycol (water content 15.0 vol %) to prepare a uniform solution. 1.0 g of 20 wt % Pt/C catalyst was added to the solution and stirred for 1 hour to prepare a uniform mixture. The mixture was heated to 50° C. to evaporate the solvent until the surface of the mixture was dried. Then, the mixture was dried in vacuum at 90° C. for 24 hours. Finally, the dried mixture was heated at a rate of 0.2° C./min and thermally treated at 200° C. for 8 hours under 10 vol % H₂/N₂ atmosphere.

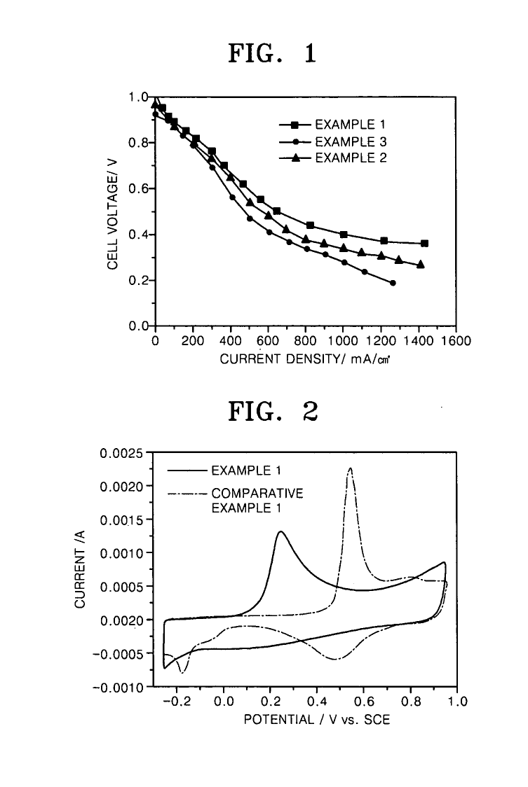

The supported catalysts of Examples 1-3 were used to manufacture electrodes. FIG. 1 is a graph illustrating the relationship between current density and operating voltage of the electrodes, in which oxygen is used as an oxidant and 100 ppm CO/H₂ is used as a fuel. Referring to FIG. 1, the voltage of the electrode using the PtRu11/C catalyst of Example 1 is relatively higher than the voltage of the electrodes using the PtRu21/C of Example 3 and the PtRu12/C of Example 2.

### EXAMPLE 4

### PtRu/C Electrochemical Catalyst of the Present Invention

0.52 g of RuCl₃ was dissolved in 3.5 mL of ethylene glycol and mixed with 2.7 mL of an aqueous solution of H₂PtCl₆.6H₂O in ethylene glycol (7.586×10⁻⁴ mol Pt/mL) to prepare a uniform solution. 1.0 g of Vulcan XC-72 conductive carbon (BET surface area 235 m²/g) was added to the solution and stirred for 1 hour to prepare a uniform mixture. The mixture was heated to 90° C. to evaporate the solvent until the surface of the mixture was dried. Then, the mixture was dried in vacuum at 150° C. for 8 hours. Finally, the dried mixture was heated at a rate of 1° C./min and thermally treated at 400° C. for 4 hours under 5 vol % H₂/N₂ atmosphere.

### EXAMPLE 5

### PtFe55/C Electrochemical Catalyst of the Present Invention

1.05 g of Fe(NO₃)₃.9H₂O was dissolved in 2.0 mL of an aqueous solution of ethylene glycol (water content 20 vol %) to prepare a uniform solution. 1.0 g of 50 wt % Pt/C catalyst was added to the solution and stirred for 1 hour to prepare a uniform mixture. The mixture was heated to 80° C. to evaporate the solvent until the surface of the mixture was dried. Then, the mixture was dried in vacuum at 110° C. for 8 hours. Finally, the dried mixture was heated at a rate of 2° C./min and thermally treated at 300° C. for 6 hours under 20 vol % H₂/Ar atmosphere.

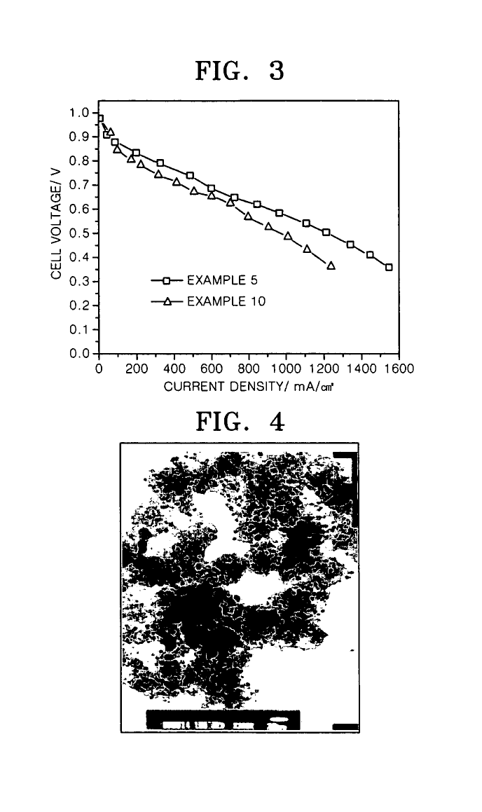

FIG. 3 is a graph illustrating catalytic performance in a cathode of a unit cell in which air is used as an oxidant and hydrogen is used as a fuel. Referring to FIG. 3, the catalyst of Example 5 has a high operating voltage. FIG. 4 is a TEM image of the catalyst of Example 5.

### EXAMPLE 6

### PtFe51/C Electrochemical Catalyst of the Present Invention

The PtFe51/C electrochemical catalyst which had a Pt/Fe atomic ratio of 5:1 was prepared as follows. 0.21 g of Fe(NO₃)₃.9H₂O was dissolved in 2.0 mL of an aqueous solution of ethylene glycol (water content 60 vol %) to prepare a uniform solution. 1.0 g of 50 wt % PVC catalyst was added to the solution and stirred for 1 hour to prepare a uniform mixture. The mixture was heated to 80° C. to evaporate the solvent until the surface of the mixture was dried. Then, the mixture was dried in vacuum at 110° C. for 8 hours. Finally, the dried mixture was heated at a rate of 10° C./min and thermally treated at 400° C. for 10 hours under 50 vol % H₂/Ar atmosphere.

### EXAMPLE 7

### PtFe12/C Electrochemical Catalyst of the Present Invention

The PtFe12/C electrochemical catalyst which had a Pt/Fe atomic ratio of 1:2 was prepared as follows. 3.06 g of Fe(NO₃)₃.9H₂O was dissolved in 3.0 mL of ethylene glycol and mixed with 5 mL of an aqueous solution of H₂PtCl₆.6H₂O in ethylene glycol (7.586×10⁻⁴ mol Pt/mL) to prepare a uniform solution. 2.0 g of Vulcan XC-72 conductive carbon was added to the solution and stirred for 1 hour to prepare a uniform mixture. The mixture was heated to 80° C. to evaporate the solvent until the surface of the mixture was dried. Then, the mixture was dried in vacuum at 110° C. for 8 hours. Finally, the dried mixture was heated at a rate of 1° C./min and thermally treated at 600° C. for 1 hour under 5 vol % H₂/He atmosphere.

### EXAMPLE 8

### PtFe14/C Electrochemical Catalyst of the Present Invention

The PtFe14/C electrochemical catalyst which had a Pt/Fe atomic ratio of 1:4 was prepared as follows. 6.12 g of Fe(NO₃)₃.9H₂O was dissolved in 3.0 mL of ethylene glycol and mixed with 5 mL of an aqueous solution of H₂PtCl₆.6H₂O in ethylene glycol (7.586×10⁻⁴ mol Pt/mL) to prepare a uniform solution. 2.0 g of BP 2000 conductive carbon (BET surface area 1450 m²/g) was added to the solution and stirred for 1 hour to prepare a uniform mixture. The mixture was heated to 80° C. to evaporate the solvent until the surface of the mixture was dried. Then, the mixture was dried in vacuum at 110° C. for 8 hours. Finally, the dried mixture was heated at a rate of 15° C./min and thermally treated at 400° C. for 3 hours under nitrogen atmosphere.

### EXAMPLE 9

### PtCo51/C Electrochemical Catalyst of the Present Invention

The PtCo51/C electrochemical catalyst which had a Pt/Co atomic ratio of 5:1 was prepared as follows. 0.221 g of Co(NO₃)₂.6H₂O was dissolved in 3.0 mL of ethylene glycol and mixed with 5 mL of an aqueous solution of H₂PtCl₆.6H₂O in ethylene glycol (7.586×10⁻⁴ mol Pt/mL) to prepare a uniform solution. 2.0 g of Vulcan XC-72 conductive carbon was added to the solution and stirred for 1 hour to prepare a uniform mixture. The mixture was heated to 80° C. to evaporate the solvent until the surface of the mixture was dried. Then, the mixture was dried in vacuum at 110° C. for 8 hours. Finally, the dried mixture was heated at a rate of 20° C./min and thermally treated at 400° C. for 2 hours under 10 vol % H₂/N₂ atmosphere.

### EXAMPLE 10

### PtCo21/C Electrochemical Catalyst of the Present Invention

The PtCo21/C electrochemical catalyst which had a Pt/Co atomic ratio of 2:1 was prepared as follows. 0.373 g of Co(NO₃)₂.6H₂O was dissolved in 2.0 mL of an aqueous solution of ethylene glycol (water content 2 vol %) to prepare a uniform solution. 1.0 g of 50 wt % Pt/C catalyst was added to the solution and stirred for 1 hour to prepare a uniform mixture. The mixture was heated to 80° C. to evaporate the solvent until the surface of the mixture was dried. Then, the mixture was dried in vacuum at 70° C. for 24 hours. Finally, the dried mixture was heated at a rate of 2° C./min and thermally treated at 300° C. for 4 hours under 5 vol % H₂/Ar atmosphere.

FIG. 3 is a graph illustrating catalytic performance in a cathode of a unit cell in which air is used as an oxidant and hydrogen is used as a fuel. Referring to FIG. 3, the catalyst of Example 10 has a high operating voltage.

The method according to an embodiment of the present invention can provide an electrochemical catalyst for PEFC, which has high activity, is simply prepared, and has active components uniformly distributed therein.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a Pt-M/C supported electrochemical catalyst for proton exchange membrane fuel cells (PEFC), comprising:
dissolving a Pt precursor and a precursor of M in a solvent to form a uniform solution;
mixing the uniform solution and a support, in which an amount of the uniform solution is a maximum amount of the uniform solution adsorbed by the support;
surface-drying the mixture by heating the mixture to evaporate the solvent and completely drying the mixture at a higher temperature than a surface-drying temperature; and
performing a thermal treatment on the mixture under H₂/inert gas atmosphere, wherein M is a transition metal or an alloy thereof.

2. The method of claim 1, wherein the M is at least one metal selected from Ru, Rh, Pd, Os, Ir, Ag, W, Cu, Fe, Co, Ni, Mo, and Mn.

3. The method of claim 1, wherein an atomic ratio of Pt to M is 10:1 to 1:10.

4. The method of claim 1, wherein the amount of active components of the Pt-M/C supported electrochemical catalyst is 5-80 wt % based on the weight of the support and the Pt-M/C supported electrochemical catalyst.

5. The method of claim 1, wherein an amount of Pt supported on the support is 5-60 wt % based on a weight of the support and the Pt-M/C supported electrochemical catalyst.

6. The method of claim 1, wherein the support is activated carbon, conductive carbon, graphite, nano-carbon tube, nano-carbon fiber, or carbon molecular sieve.

7. The method of claim 1, wherein the solvent is a C₂-C₈ binary alcohol or ternary alcohol, or a mixture of a C₂-C₈ binary alcohol or ternary alcohol and water and an amount of water in the solvent is 0-60 vol %.

8. The method of claim 1, wherein the solvent is ethylene glycol or an aqueous solution thereof.

9. The method of claim 1, wherein the inert gas is Ar, He or N₂ and the content of H₂ in H₂/inert gas is 0-90 vol %.

10. The method of claim 1, wherein a heating rate of the thermal treatment is 0.1-20° C./min.

11. The method of claim 1, wherein a thermal treatment temperature is 200-600° C.

12. The method of claim 1, wherein a surface-drying temperature is 50-95° C.

13. The method of claim 1, wherein the higher temperature than the surface-drying temperature at which the mixture is completely dried is 60-150° C.

14. The method of claim 1, wherein the drying of the mixture at the higher temperature than the surface-drying temperature is performed for 2-24 hours.

15. The method of claim 1, wherein the thermal treatment is performed for 0.5-10 hours.

16. A method of preparing an electrochemical catalyst, comprising:
dissolving a Pt precursor and a precursor of an active component in a solvent to form a uniform solution;
mixing the uniform solution and a support to form a mixture;
surface-drying the mixture by heating the mixture to evaporate the solvent;
drying the mixture at a temperature higher than the surface-drying temperature; and
performing a thermal treatment on the dried mixture under an H₂/inert gas atmosphere,
wherein an amount of the uniform solution is a maximum amount of the uniform solution that is adsorbed by the support.

17. The method of claim 16, wherein the active component is at least one metal selected from Ru, Rh, Pd, Os, Ir, Ag, W. Cu, Fe, Co, Ni, Mo and Mn.

18. The method of claim 16, wherein the solvent is a C₂-C₈ binary alcohol or a C₂-C₈ ternary alcohol, or a mixture of a C₂-C₈ binary alcohol or ternary alcohol and water and an amount of water in the solvent is 0-60 vol %.

19. The method of claim 16, wherein the support is activated carbon, conductive carbon, graphite, nano-carbon tube, nano-carbon fiber, or carbon molecular sieve or a Pt/C catalyst.

20. The method of claim 16, wherein the atomic ratio of Pt to the active component is 10:1 to 1:10.

21. The method of claim 16, wherein the active component is uniformly distributed in the electrochemical catalyst.
